(19) United States
(12) Patent Application Publication
(10) Pub. No.: US 2020/0380263 A1
(43) Pub. Date: Dec. 3, 2020

(54) DETECTING KEY FRAMES IN VIDEO COMPRESSION IN AN ARTIFICIAL INTELLIGENCE SEMICONDUCTOR SOLUTION

(71) Applicant: Gyrfalcon Technology Inc., Milpitas, CA (US)

(72) Inventors: Lin Yang, Milpitas, CA (US); Bin Yang, San Jose, CA (US); Qi Dong, San Jose, CA (US); Xiaochun Li, San Ramon, CA (US); Wenhan Zhang, Mississauga (CA); Yinbo Shi, Santa Clara, CA (US); Yequn Zhang, San Jose, CA (US)

(73) Assignee: Gyrfalcon Technology Inc., Milpitas, CA (US)

(21) Appl. No.: 16/425,858

(22) Filed: May 29, 2019

(51) Int. Cl. G06K 9/00; G06K 9/62; G06T 3/40; H04N 19/136; H04N 19/172; G06N 3/04

(52) U.S. Cl. CPC G06K 9/00744; G06K 9/6232; G06T 3/40; G06K 2009/00738; H04N 19/136; H04N 19/172; G06N 3/04; G06K 9/6215

(57) ABSTRACT

A system for detecting key frames in a video may include a feature extractor configured to extract feature descriptors for each of the multiple image frames in the video. The feature extractor may be an embedded cellular neural network of an artificial intelligence (AI) chip. The system may also include a key frame extractor configured to determine one or more key frames in the multiple image frames based on the corresponding feature descriptors of the image frames. The key frame extractor may determine the key frames based on distance values between a first set of feature descriptors corresponding to a first subset of image frames and a second set of feature descriptors corresponding to a second subset of image frames. The system may output an alert based on determining the key frames and/or display the key frames. The system may also compress the video by removing the non-key frames.

### FIELD

This patent document relates generally to systems and methods for detecting key image frames in a video. Examples of implementing key frame detection in video compression in an artificial intelligence semiconductor solution are provided.

### BAC KGROUND

In video analysis and other applications, such as video compression, key frame detection generally determines the image frames in a video where an event has occurred. The examples of an event may include a motion, a scene change or other condition changes in the video. Key frame detection generally processes multiple image frames in the video and may require extensive computing resources. For example, if a video is captured in 30 frames per second, such technologies may require large computing power to be able to process the multiple image frames in real-time because of the large amount of pixels in the video. Other technologies may include selecting a subset of image frames in a video either at a fixed time interval or a random time interval, without assessing the content of the images in the video. However, these methods may be less than ideal because the frames selected may not be the true key frames that reflect when an event occurs. Converse, a true key frame may be missed. Alternatively, some of the compression techniques may be implemented in a hardware solution, such as in an application-specific integrated circuit (ASIC). However, a custom ASIC requires a long design cycle and is expensive to fabricate.

This document is directed to systems and methods for addressing the above issues and/or other issues.

### BRIEF DESCRIPTION OF THE DRAWINGS

The present solution will be described with reference to the following figures, in which like numerals represent like items throughout the figures.

FIG. 1 illustrates a diagram of an example key frame detection system in accordance with various examples described herein.

FIGS. 2-3 illustrates diagrams of an example feature extractor that may be embedded in an AI chip in accordance with various examples described herein.

FIG. 4 illustrates a flow diagram of an example process of detecting key frames in accordance with various examples described herein.

FIG. 5 illustrates a flow diagram of an example process in one or more applications that may utilize key frame detection in accordance with various examples described herein.

FIG. 6 illustrates various embodiments of one or more electronic devices for implementing the various methods and processes described herein.

### DETAILED DESCRIPTION

As used in this document, the singular forms “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to.”

Each of the terms “artificial intelligence logic circuit” and “AI logic circuit” refers to a logic circuit that is configured to execute certain AI functions such as a neural network in AI or machine learning tasks. An AI logic circuit can be a processor. An AI logic circuit can also be a logic circuit that is controlled by an external processor and executes certain AI functions.

Each of the terms “integrated circuit,” “semiconductor chip,” “chip,” and “semiconductor device” refers to an integrated circuit (IC) that contains electronic circuits on semiconductor materials, such as silicon, for performing certain functions. For example, an integrated circuit can be a microprocessor, a memory, a programmable array logic (PAL) device, an application-specific integrated circuit (ASIC), or others. An integrated circuit that contains an AI logic circuit is referred to as an AI integrated circuit.

The term “AI chip” refers to a hardware- or software-based device that is capable of performing functions of an AI logic circuit. An AI chip can be a physical IC. For example, a physical AI chip may include an embedded CeNN, which may contain weights and/or parameters of a CNN. The AI chip may also be a virtual chip, i.e., software-based. For example, a virtual AI chip may include one or more processor simulators to implement functions of a desired AI logic circuit of a physical AI chip.

The term of “AI model” refers to data that include one or more weights that, when loaded inside an AI chip, are used for executing the AI chip. For example, an AI model for a given CNN may include the weights, biases, and other parameters for one or more convolutional layers of the CNN. Here, the weights and parameters of an AI model are interchangeable.

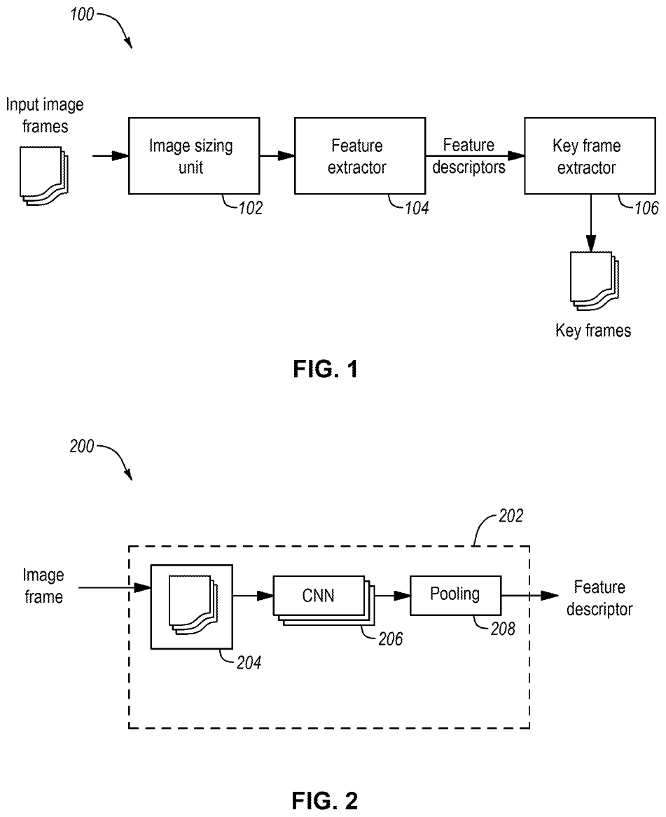

FIG. 1 illustrates an example key frame detection and video compression system in accordance with various examples described herein. A system 100 may include a feature extractor 104 configured to extract one or more feature descriptors from an input image. Examples of a feature descriptor may include any values that are representative of one or more features of an image. For example, the feature descriptor may include a vector containing values representing multiple channels. In a non-limiting example, an input image may have 3 channels, whereas the feature map from the CNN may have 512 channels. In such case, the feature descriptor may be a vector having 512 values. In some examples, the feature extractor may be implemented in an AI chip. The system 100 may also include a key frame extractor 106. The key frame extractor 106 may assess the feature descriptors obtained from the feature extractor 104 to determine one or more key frames in a video. In some examples, the system 100 may access multiple image frames of a video segment, such as a sequence of image frames. For example, the system may access a video segment stored in a memory or on the cloud over a communication network (e the Internet), and extract the sequence of image frames in the video segment. In some or other scenarios, the system may receive a video segment or plurality of image frames directly from an image sensor. The image sensor may be configured to capture a video or an image. For example, the image sensor may be installed in a video surveillance system and configured to capture video/images at an entrance of a garage, a parking lot, a building, or any scenes or objects.

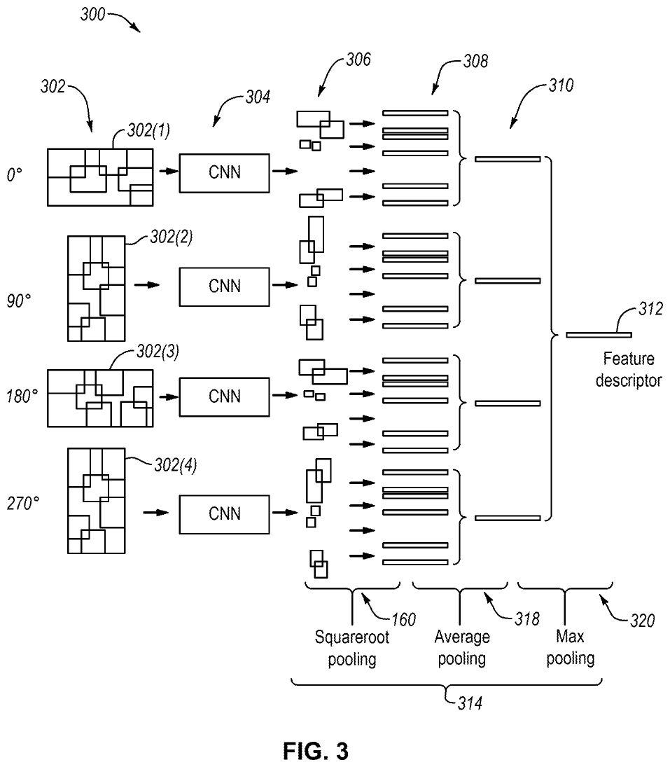

In some examples, the system 100 may further include an image sizing unit 102 configured to reduce the sizes of the plurality of image frames to a proper size so that the plurality of image frames are suitable for uploading to an AI chip. For example, the AI chip may include a buffer for holding input images up to 224×224 pixels for each channel. In such case, the image sizing unit 102 may reduce each of the image frames to a size at or smaller than 224×224. In a non-limiting example, the image sizing unit 102 may down sample each image frame to the size constrained by the AI chip. In another example, the image sizing unit 102 may crop each of the plurality of image frames to generate multiple instances of cropped images. For example, for an image frame having a size of 640×480, the instances of cropped images may include one or more sub-images, each of the sub-images being smaller than the original image and cropped from a region of the original image. In a non-limiting example, the system may crop the input image in a defined pattern to obtain multiple overlapping sub-images which cover the entire original image. In other words, each of the cropped images may contain image contents attributable to a feature descriptor based on each cropped image. Accordingly, for an image frame, the feature extractor 104 may access multiple instances of cropped images and produce a feature descriptor based on the multiple instances of cropped images. The details will be further described with reference to FIG. 2.

FIG. 2 illustrates an example feature extractor that may be embedded in an AI chip in accordance with various examples described herein. In some examples, the feature extractor, such as the feature extractor 104 (in FIG. 1) may be implemented in an embedded CeNN of an AI chip 202. For example, the AI chip 202 may include a CNN 206 configured to generate feature maps for each of the plurality of image frames. The CNN 206 may be implemented in the embedded CeNN of the AI chip. The AI chip 202 may also include an invariance pooling layer 208 configured to generate the corresponding feature descriptor based on the feature maps. In some examples, the AI chip 202 may further include an image rotation unit 204 configured to produce multiple images rotated from the image frame at corresponding angles. This allows the CNN to be able to extract deep features off of the image.

In some examples, the invariant pooling layer 208 may be configured to determine a feature descriptor based on the feature maps obtained from the CNN. The pooling layer 208 may include a square-root pooling, an average pooling, a max pooling or a combination thereof. The CNN may also be configured to perform a region of interest (ROI) sampling on the feature maps to generate multiple updated feature maps. The various pooling layers may be configured to generate a feature descriptor for various rotated images.

FIG. 3 illustrates an example feature extractor that may be embedded in a CeNN in an AI chip in accordance with various examples described herein. In some examples, the CeNN may be a deep neural network (e.g., VGG-16), in such case, the feature descriptors may be deep feature descriptors. The feature extractor 300 may be configured to generate a feature descriptor for an input image. In generating the feature descriptor, the feature extractor may be configured to generate multiple rotated images 302 (e.g., 302(1), 302(2) 302(3), 302(4)), each being rotated from the input image at a different angle, e.g., 0, 90, 180 and 270 or other angles. Each rotated image may be fed to the CNN 304 to generate multiple feature maps 306, where each feature map represents a rotated image. The feature extractor may concatenate (stack) the feature maps from different image rotations. An invariance pooling 314 may be performed on the stacked feature maps to generate a feature descriptor, as will be further described.

Additionally, each of the feature maps from various image rotations may be nested to include multiple cropped images (regions) from the input image. The cropped images may be fed to the CNN to generate multiple feature maps, each of the feature maps representing a cropped region. The feature extractor may further concatenate (stack) the features maps from multiple cropped images nested in each set of feature maps from an image rotation. In other words, each feature map from a rotated image may include a set of feature maps comprising multiple feature maps that are concatenated (stacked together), where each feature map in the set results from a respective cropped image from a respective rotated image. As the cropped images from an input image (or rotated input image) may have different sizes, the feature maps within each set of feature maps may also have different sizes.

Additionally, and/or alternatively, a region of interest (ROI) sampling may be performed on top of each set (stack) of feature maps. Various ROI methods may be used to select one or more regions of interest from each of the feature maps. Thus, a feature map in the set of feature maps for an image rotation may be further nested to include multiple sub-feature maps, each representing a ROI within that feature map. For example, an image of a size of 640×480 may result in a feature map of a size of 20×15. In a non-limiting example, the feature extractor 300 may generate two ROI samplings, each having a size of 15×15, where the two ROI samplings may be overlapping, covering the entire feature map. In another non-limiting example, the feature extractor 300 may generate six ROI samplings, each having a size of 10×10, where the six ROI samplings may be overlapping, covering the entire feature map. All of the feature maps for all image rotations and the nested sub-feature maps for ROIs within each feature map may be concatenated (stacked together) for performing the invariance pooling.

In some examples, the invariance pooling 314 may be a nested invariance pooling and may include one or more pooling operations. For example, the invariance pooling 314 may include a square-root pooling 316 performed on the ROIs of all concatenated feature/sub-feature maps to generate a plurality of values 308, each representing the square-root values of the pixels in the respective ROI. Further, the invariance pooling 314 may include an average pooling 318 to generate a feature vector 310 for each set of feature maps (corresponding to each image rotation, e.g., at 0, 90, 180 and 270 degrees, respectively), each feature vector corresponding to an image rotation and based on an average of the square-root values from multiple sub-feature maps. Further, the invariance pooling 314 may include a Max pooling 320 to generate a single feature descriptor 312 based on the maximum values of the feature vectors 310 obtained from the average pooling. As shown, for each of a plurality of image frames of a video segment, the feature extractor may generate a corresponding feature descriptor, such as 312. In a non-limiting example, the feature descriptor may include a one-dimensional (1D) vector containing multiple values. The number of values in the 1D descriptor vector may correspond to the number of output channels in the CNN.

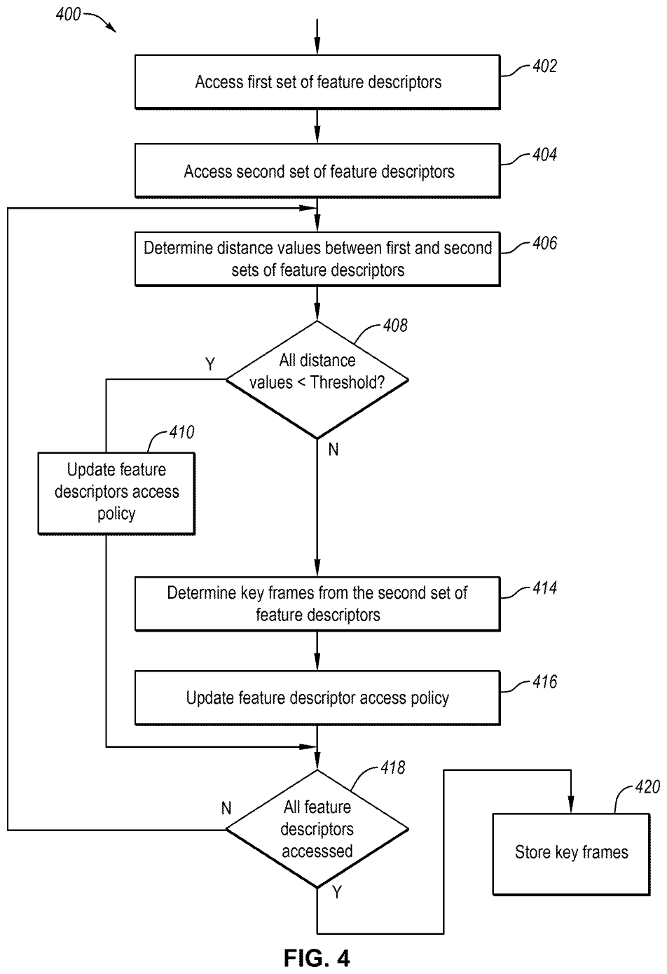

FIG. 4 illustrates a flow diagram of an example process of detecting key frames in accordance with various examples described herein. A process 400 for detecting key frames in a video segment may be implemented in a key frame extractor, such as 106 in FIG. 1. The process 400 may include accessing a first set of feature descriptors at 402 and accessing a second set of feature descriptors at 404, where the first set of feature descriptors correspond to a first subset of the plurality of image frames in the video segment and the second set of feature descriptors correspond to a second subset of image frames in the video segment. For example, the first subset of images may include frames 1-10 and the second subset of images may include frames 11-20. In such case, the first set of feature descriptors may include 10 feature descriptors (e.g., feature descriptor 312 in FIG. 3) each corresponding to a respective image frame in frames 1-10. The second set of feature descriptors may include 10 feature descriptors (e.g., feature descriptor 312 in FIG. 3) each corresponding to a respective image frame in frames 11-20. The process 400 may determine distance values between the first and second sets of feature descriptors at 406.

In a non-limiting example, determining the distance values between two sets of feature descriptors may include calculating a distance value between a feature descriptor pair containing a feature descriptor from the first set and a corresponding feature descriptor from the second set. In the example above, the first set of feature descriptors may include 10 vectors each corresponding to a frame between 1-10 and the second set of feature descriptors may include 10 vectors each corresponding to a respective frame between 11-20. Then, the process of determining the distance values between the first and second sets of feature descriptors may include determining multiple distance values. For example, the process may determine a first distance value between the feature descriptor corresponding to frame 1 (from the first set) and the feature descriptor corresponding to frame 11 (from the second set). The process my determine the second distance value based on the descriptor corresponding to frame 2 and the descriptor corresponding to frame 12. The process may determine other distance values in a similar mariner.

In some examples, in determining the distance value, the process 406 may use a cosine distance. For example, if a vector in the first set of feature descriptors is u, and the corresponding vector in the second set of feature descriptors is v, then the cosine distance between vectors u and v is:

$$1 - \frac{u \cdot v}{{‖ u ‖}_{2} {‖ v ‖}_{2}}$$

where u-v is the dot product of u and v, and ∥u∥₂ and ∥v∥₂ are Euclidean norms. In an example, if u and v have the same direction, then the cosine distance may have a minimal value, such as zero. If u and v are perpendicular to each other, then the cosine distance may have a maximum value, e.g., a value of one. In here, the distance value between two feature descriptors corresponding to two image frames may indicate the extent of changes between the two image frames. A higher distance value may indicate a more significant difference between the two corresponding image frames (which may indicate an occurrence of an event) than a lower distance value does. In other words, if a distance value between two feature descriptors exceeds a threshold, the system may determine that an event has occurred between the corresponding image frames. For example, the event may include a motion in the image frame (e.g., a car passing by in a surveillance video) or a scene change (e.g., a camera installed on a vehicle capturing a scene change when driving down the road), or change of other conditions. In such case, the process may determine that the frames where the significant changes have occurred in the corresponding feature descriptors be key frames. Conversely, a lower distance value between the feature descriptors of two image frames may indicate less significant change or no change between the two image frames, which may indicate that the two image frames contain static background of the image scenes. In such case, the process may determine that such image frames are not key frames.

With further reference to FIG. 4, the process may determine whether all distances values between the two sets of feature descriptors (corresponding to two subsets of image frames) are below a threshold at 408. If all distances values between the two sets of feature descriptors are below a threshold, the process may determine that the corresponding image frames contain background of the image scenes and are not key frames. If at least one distance value is above the threshold, then the process may determine that the corresponding image frames contain non-background information or indicate that an event has occurred. In such case, the process may determine one or more key frames from the second set of feature descriptors at 414.

In a non-limiting example, the process 414 may select the key frames from the top feature descriptors which resulted in distance values exceeding the threshold. In the example above, if the feature descriptors of frames 14 and 15 are above the threshold, then the process 414 may determine that frames 14 and 15 are key frames. Additionally, and/or alternatively, if the feature descriptors of multiple frames in the second subset of image frames have exceed the threshold, the process may select one or more top key frames whose corresponding feature descriptors have yielded highest distance values. For example, between frames 14 and 15, the process may select frame 15, which yields a higher distance value than frame 14 does. In another non-limiting example, if image frames 11, 12, 14, 15 all yield distance values above the threshold, the process may select all of these image frames as key frames. Alternatively, the process may select two key frames whose feature descriptors yield the two highest distance values. It is appreciated that other ways of selecting key frames based on the distance values may also be possible.

Now the first and second sets of feature descriptors are processed, the process 400 may move to process additional feature descriptors. In some examples, the process 400 may update a feature descriptor access policy at 410, 416 depending whether one or more key frames are detected. For example, if one or more key frames are detected at 414, the process 416 may update the first set of feature descriptors to include the current second set of feature descriptors, and update the second set of feature descriptors to include additional feature descriptors corresponding to a third subset of image frames of the plurality of image frames. In the above example, the first set of feature descriptors may be updated to include the second set of feature descriptors, such as the feature descriptors corresponding to frames 11-20; and the second set of feature descriptors may be updated to include a new set of feature descriptors corresponding to frames 21-30. In such case, subsequent distance values between the first and second sets of feature descriptors may be determined based on the feature descriptors corresponding to image frames 11-20 and 21-30, respectively.

Alternatively, if no key frames are detected at 414, then the process 410 may update the second set of feature descriptors to include additional feature descriptors corresponding to a third subset of image frames of the plurality of image frames. For example, if no key frames are detected in frames 11-20, then the second set of feature descriptors may include feature descriptors corresponding to the new set of frames 21-30. In some examples, the first set of feature descriptors may remain unchanged. For example, the first set of feature descriptors may remain the same and correspond to image frames 1-10. Alternatively, the first set of feature descriptors may be set to one of the feature descriptors. For example, the first set of feature descriptors may include the feature descriptor corresponding to image frame 10. In such case, subsequent distance values between the first and second sets of feature descriptors may be determined based on the feature descriptor corresponding to image frame 10 and feature descriptors corresponding to image frames 21-30. In other words, the image frames 11-20 are ignored.

In some examples, the process 400 may repeat blocks 406-416 until the process determines that the feature descriptors corresponding to all of the plurality of images frames in the video segment have been accessed at 418. When such determination is made, the process 400 may store the key frames at 420. Otherwise, the process 400 may continue repeating 406-416. In some variations, block 420 may be implemented when all feature descriptors have been accessed at 418. Alternatively, and/or additionally, block 420 may be implemented as key frames are detected (e.g., at 414) in one or more of the iterations.

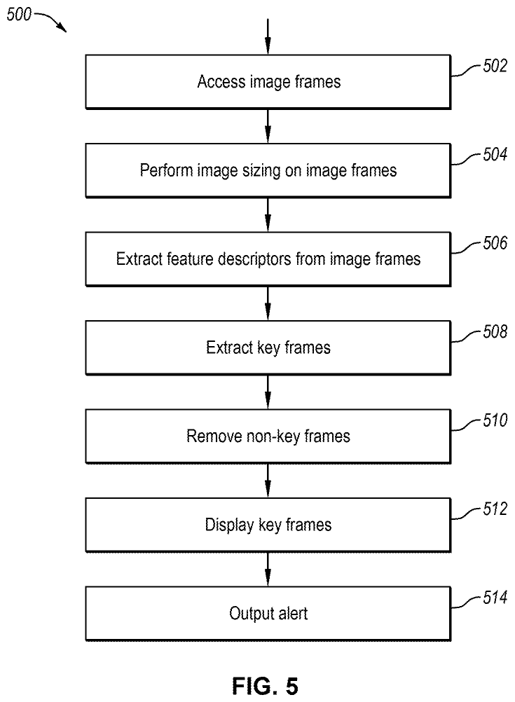

Various embodiments described in FIGS. 1-4 may be implemented to enable various applications. FIG. 5 illustrates a flow diagram of an example process in one or more applications that may utilize key frame detection in accordance with various examples described herein. In some examples, in a video surveillance application, a process 500 may include accessing a sequence of image frames at 502. The sequence of image frames may comprise at least a part of a video segment stored in a server or on the cloud. For example, a surveillance video of a premises is recorded and stored on a server. The sequence of images may include all of the image frames recorded from the video. Alternatively, the sequence of images may include sampled image frames (e.g., every 10 frames) recorded from the video. The image frames may be streamed to the system for detecting the key frames, such as 100 in FIG. 1. The process 500 may access the image frames in the video for a duration of time. For example, the process 500 may access a one-hour video at a certain time when an operator of the video surveillance application wants to learn whether any events have occurred. If the video is recorded in 30 frames per second, the image frames may include 30 fps×3600 s=108,000 frames.

The process 500 may further extract feature descriptors from the image frames at 506 in a similar manner as the feature extractor described with reference to FIGS. 1-3 (e.g., 104 in FIG. 1, 202 in FIG. 2, 300 in FIG. 3). For example, extracting feature descriptors at 506 may be implemented in a CeNN of an AI chip. Additionally, the process 500 may perform image sizing on the image frames at 504 so that the re-sized image frames may be suitable for the buffer size of the AI chip and thus suitable for uploading to the AI chip. Image resizing may be implemented by image cropping in a similar manner as described in FIGS. 1 and 3. The process 500 may further include extracting key frames at 508 based on the feature descriptors, in a similar manner as described with reference to FIG. 4. The process 508 may produce one or more key frames, which may be stored in a memory (e.g., in block 420 in FIG. 4).

In some examples, the process 500 may display the key frames at 512 on a display device. For example, the process 500 may display key frames in a sliding show on a display to facilitate the user to view the video in a fast forward fashion by showing only frames with events occurred and skipping static background frames. In the above example, an operator may access the video of interest and display the key frames to be able to ascertain whether an event has occurred in the video. Alternatively, the process may, for each key frame, display the video for a short duration, e.g., a few seconds, before and after the key frame. Subsequently, the process may display a short video segment around the next key frame, so on and so forth. Alternatively, and/or additionally, the process may include outputting an alert at 514 to alert the operator that an event has occurred. In some examples, the features used in detecting the key frames (e.g., 508) may represent a motion in the sequence of image frames in the surveillance video. In such case, the alert may indicate that a motion is detected. In some examples, the alert may include an audible alert (e.g., via a speaker), a visual alert (e.g., via a display), or a message transmitted to an electronic device associated with the video surveillance system. For example, an alert message (associated with detection of one or more key frames) may be sent to an electronic mobile device associated with the operator. Alternatively, andlor additionally, an alert message may be sent to a remote monitoring server via a communication network.

In some examples, in a video compression application, the process 500 may be implemented as previously described to compress a video segment. The process 500 may be implemented to extract the key frames. Additionally, and/or alternatively, once the key frames are detected in the video segment, the process 500 may remove the non-key frames at 510. In other words, the process may update the video segment and save only key frames, while leaving non-key frames out. As such, the video segment is compressed. The process may save the video segment as a compressed video file or transmit the compressed video segment to one or more electronic devices via a communication network.

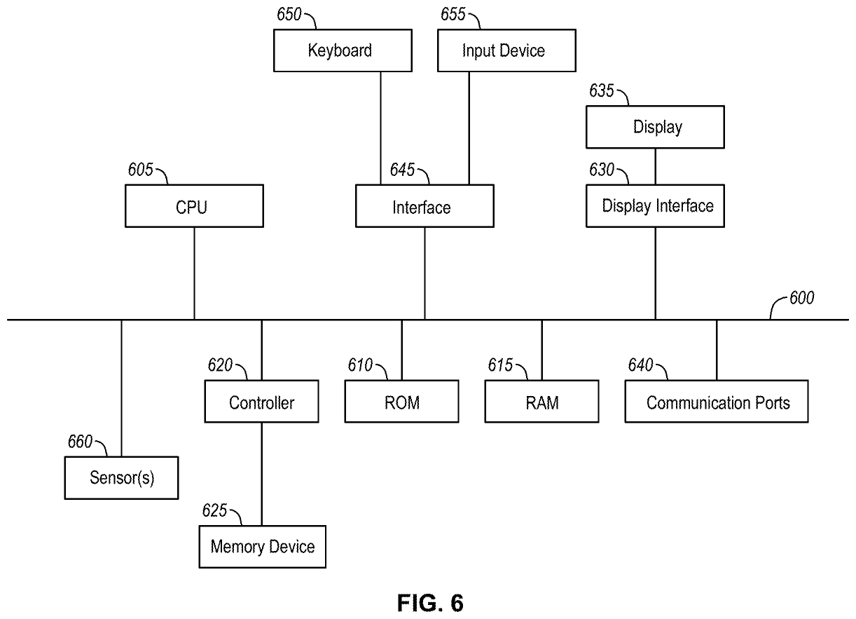

FIG. 6 illustrates various embodiments of one or more electronic devices for implementing the various methods and processes described in FIGS. 1-5. An electrical bus 600 serves as an information highway interconnecting the other illustrated components of the hardware. Processor 605 is a central processing device of the system, configured to perform calculations and logic operations required to execute programming instructions. As used in this document and in the claims, the terms “processor” and “processing device” may refer to a single processor or any number of processors in a set of processors that collectively perform a process, whether a central processing unit (CPU) or a graphics processing unit (GPU), or a combination of the two. Read only memory (ROM), random access memory (RAM), flash memory, hard drives, and other devices capable of storing electronic data constitute examples of memory devices 625. A memory device, also referred to as a computer-readable medium, may include a single device or a collection of devices across which data and/or instructions are stored.

An optional display interface 630 may permit information from the bus 600 to be displayed on a display device 635 in visual, graphic, or alphanumeric format. An audio interface and audio output (such as a speaker) also may be provided. Communication with external devices may occur using various communication ports 640 such as a transmitter and/or receiver, antenna, an RFID tag and/or short-range, or near-field communication circuitry. A communication port 640 may be attached to a communications network, such as the Internet, a local area network, or a cellular telephone data network.

The hardware may also include a user interface sensor 645 that allows for receipt of data from input devices 650 such as a keyboard, a mouse, a joystick, a touchscreen, a remote control, a pointing device, a video input device, and/or an audio input device, such as a microphone. Digital image frames may also be received from an image capturing device 655 such as a video or camera that can either be built-in or external to the system. Other environmental sensors 660, such as a GPS system and/or a temperature sensor, may be installed on system and communicatively accessible by the processor 605, either directly or via the communication ports 640. The communication ports 640 may also communicate with the AI chip to upload or retrieve data to/from the chip. For example, a processing device on the network may be configured to perform operations in the image sizing unit (FIG. 1) to and upload the image frames to the AI chip for performing feature extraction via the communication port 640. Optionally, the processing device may use an SDK (software development kit) to communicate with the AI chip via the communication port 640. The processing device may also retrieve the feature descriptors at the output of the AI chip via the communication port 640. The communication port 640 may also communicate with any other interface circuit or device that is designed for communicating with an integrated circuit.

Optionally, the hardware may not need to include a memory, but instead programming instructions are run on one or more virtual machines or one or more containers on a cloud. For example, the various methods illustrated above may be implemented by a server on a cloud that includes multiple virtual machines, each virtual machine having an operating system, a virtual disk, virtual network and applications, and the programming instructions for implementing various functions in the robotic system may be stored on one or more of those virtual machines on the cloud.

Various embodiments described above may be implemented and adapted to various applications. For example, the AI chip having a CeNN architecture may be residing in an electronic mobile device. The electronic mobile device may use a built-in AI chip to generate the feature descriptor. In some scenarios, the mobile device may also use the feature descriptor to implement a video surveillance application such as described with reference to FIG. 5. In other scenarios, the processing device may be a server device on a communication network or may be on the cloud. The processing device may implement a CeNN architecture or access the feature descriptor generated from the AI chip and perform image retrieval based on the feature descriptor. These are only examples of applications in which various systems and processes may be implemented.

The various systems and methods disclosed in this patent document provide advantages over the prior art, whether implemented, standalone, or combined. For example, by using an AI chip to generate feature descriptors for a plurality of image frames in a video, the amount of information for key frame detection are reduced from a two-dimensional array of pixels to a single vector. This is advantageous in that the processing associated with key detection is done at feature vector level instead of pixel level, allowing the process to take into consideration a richer set of image features while reducing the memory space required for detecting key frames at pixel level. Further, the image cropping as described in various embodiments herein provide advantages in representing a richer set of image features in one or more cropped images with smaller size. In comparing to simple down sampling, the cropping method may also reduce the image size, without losing image features, so that the images are suitable for uploading to a physical AI chip.

It will be readily understood that the components of the present solution as generally described herein and illustrated in the appended figures could be arranged and designed in a wide variety of different configurations. For examples, various operations of the invariance pooling may vary in order. Alternatively, some operations in the invariance pooling may be optional. Furthermore, the process of extracting key frames based on the feature descriptors may also vary. Thus, the detailed description of various implementations, as represented herein and in the figures, is not intended to limit the scope of the present disclosure, but is merely representative of various implementations. While the various aspects of the present solution are presented in drawings, the drawings are not necessarily drawn to scale unless specifically indicated.

The present solution may be embodied in other specific forms without departing from its spirit or essential characteristics. The described embodiments are to be considered in all respects only as illustrative and not restrictive. The scope of the present solution is, therefore, indicated by the appended claims rather than by this detailed description. All changes which come within the meaning and range of equivalency of the claims are to be embraced within their scope.

Reference throughout this specification to features, advantages, or similar language does not imply that all of the features and advantages that may be realized with the present solution should be or are in any single embodiment thereof Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages, and characteristics of the present solution may be combined in any suitable manner in one or more embodiments. It is appreciated that, in light of the description herein, the present solution can be practiced without one or more of the specific features or advantages of a particular embodiment. In other instances, additional features and advantages may be recognized in certain embodiments that may not be present in all embodiments of the present solution.

Other advantages can be apparent to those skilled in the art from the foregoing specification. Accordingly, it will be recognized by those skilled in the art that changes, modifications, or combinations may be made to the above-described embodiments without departing from the broad inventive concepts of the invention. It should therefore be understood that the present solution is not limited to the particular embodiments described herein, but is intended to include all changes, modifications, and all combinations of various embodiments that are within the scope and spirit of the invention as defined in the claims.

What is claimed is:

1. A system comprising:
a processor; and
non-transitory computer readable medium containing programming instructions that, when executed, will cause the processor to:
access a plurality of image frames of a video segment;
for each of the plurality of image frames, use an artificial intelligence (AI) chip to determine a corresponding feature descriptor; and
determine one or more key frames of the plurality of image frames based at least on the corresponding feature descriptors of the plurality of image frames.

2. The system of claim 1, wherein the AT chip comprises:
an embedded cellular neural network (CeNN) configured to generate feature maps for each of the plurality of image frames; and
an invariance pooling layer configured to generate the corresponding feature descriptor based on the feature maps.

3. The system of claim 2 further comprising an image sizing unit configured to generate a plurality of instances of cropped images from each of the plurality of image frames, wherein the CeNN of the AI chip is configured to:
generate multiple feature maps, each representing an instance of cropped images; and
concatenate the multiple feature maps.

4. The system of claim 3, wherein the invariance pooling is configured to generate the corresponding feature descriptor based on the concatenated feature maps obtained from one or more instances of cropped images from each of the plurality of image frames.

5. The system of claim 1, wherein the programming instructions comprise additional programming instructions configured to output an alert at an output device based on the determining one or more key frames.

6. The system of claim 2, wherein the CeNN is configured to generate the feature maps for each image frame of the plurality of image frames based on multiple images rotated from the image frame at corresponding angles.

7. The system of claim 1, wherein programming instructions for determining the key frames comprise programming instructions configured to:
(i) access a first set of feature descriptors corresponding to a first subset of the plurality of image frames in the video segment;
(ii) access a second set of feature descriptors corresponding to a second subset of the plurality of image frames in the video segment;
(iii) determine distance values between the first and second sets of feature descriptors;
(iv) determine, based on the distance values, whether one or more distance values have exceeded a threshold;
(v) upon determining that one or more distance values have exceeded the threshold, determine the one or more key frames from the second subset of the plurality of image frames;
(vi) update feature descriptors access policy; and
(vii) repeat (iii)-(vi) until feature descriptors corresponding to all of the plurality of images frames in the video segment have been accessed.

8. The system of claim 7, wherein programming instructions for updating the feature descriptors access policy comprises:
upon determining that one or more distance values have exceeded the threshold:
updating the first set of feature descriptors to include the second set of feature descriptors; and
updating the second set of feature descriptors to include additional feature descriptors corresponding to a third subset of image frames of the plurality of image frames:
otherwise:
updating the second set of feature descriptors to include additional feature descriptors corresponding to a third subset of image frames of the plurality of image frames.

9. A method comprising, at a processing device:
accessing a plurality of image frames of a video segment;
for each of the plurality of image frames, using an artificial intelligence (AI) chip to determine a corresponding feature descriptor; and
determining one or more key frames of the plurality of image frames based at least on the corresponding feature descriptors of the plurality of image frames; and
outputting an alert at an output device based on the determining one or more key frames.

10. The method of claim 9, wherein the AI chip comprises:
a convolution neural network (CNN) configured to generate feature maps for each of the plurality of image frames; and
an invariance pooling layer configured to generate the corresponding feature descriptor based on the feature maps, wherein the invariance pooling layer comprises a square-root pooling, an average pooling and a max pooling.

11. The method of claim 10 further comprising:
generating a plurality of instances of cropped images from each of the plurality of image frames;
at the CNN of the AI chip, generating multiple feature maps, each representing an instance of cropped images; and
concatenating the multiple feature maps.

12. The method of claim 11 further comprising, at the invariance pooling layer of the AI chip, generating the corresponding feature descriptor based on the concatenated feature maps obtained from one or more instances of cropped images from each of the plurality of image frames.

13. The method of claim 9, wherein determining the key frames comprises:
(i) accessing a first set of feature descriptors corresponding to a first subset of the plurality of image frames in the video segment;
(ii) accessing a second set of feature descriptors corresponding to a second subset of the plurality of image frames in the video segment;
(iii) determining distance values between the first and second sets of feature descriptors;
(iv) determining, based on the distance values, whether one or more distance values having exceeded a threshold;
(v) upon determining that one or more distance values have exceeded the threshold, determining the one or more key frames from the second subset of the plurality of image frames;
(vi) updating feature descriptors access policy; and
(vii) repeating (iii)-(vi) until feature descriptors corresponding to all of the plurality images frames in the video segment have been accessed.

14. The method of claim 13, wherein updating the feature descriptors access policy comprises:
upon determining that one or more distance values have exceeded the threshold:
updating the first set of feature descriptors to include the second set of feature descriptors; and
updating the second set of feature descriptors to include additional feature descriptors corresponding to a third subset of image frames of the plurality of image frames:
otherwise:
updating the second set of feature descriptors to include additional feature descriptors corresponding to a third subset of image frames of the plurality of image frames.

15. An video compression system comprising:
a processor; and
non-transitory computer readable medium containing programming instructions that, when executed, will cause the processor to:
access a plurality of image frames of a video segment;
for each of the plurality of image frames. use an artificial intelligence (AI) chip to determine a corresponding feature descriptor;
determine one or more key frames of the plurality of image frames based at least on the corresponding feature descriptors of the plurality of image frames;
update the video segment by removing non-key frames from the video segment; and
communicate the updated video segment to one or more electronic devices in a communication network.

16. The video compression system of claim 15, wherein the AI chip comprises:
an embedded cellular neural network (CeNN) configured to generate feature maps for each of the plurality of image frames; and
an invariance pooling layer configured to generate the corresponding feature descriptor based on the feature maps.

17. The video compression system of claim 16 further comprising an image sizing unit configured to generate a plurality of instances of cropped images from each of the plurality of image frames, wherein the CeNN of the AI chip is configured to:
generate multiple feature maps, each representing an instance of cropped images; and
concatenate the multiple feature maps.

18. The video compression system of claim 17, wherein the invariance pooling layer of the AI chip is configured to generate the corresponding feature descriptor based on the concatenated feature maps obtained from one or more instances of cropped images from each of the plurality of image frames.

19. The video compression system of claim 15, wherein programming instructions for determining the key frames comprise programming instructions configured to:
(i) access a first set of feature descriptors corresponding to a first subset of the plurality of image frames in the video segment;
(ii) access a second set of feature descriptors corresponding to a second subset of the plurality of image frames in the video segment;
(iii) determine distance values between the first and second sets of feature descriptors;
(iv) determine, based on the distance values, whether one or more distance values have exceeded a threshold;
(v) upon determining that one or more distance values have exceeded the threshold, determine the one or more key frames from the second subset of the plurality of image frames;
(vi) update feature descriptors access policy; and
(vii) repeat (iii)-(vi) until feature descriptors corresponding to all of the plurality of images frames in the video segment have been accessed.

20. The video compression system of claim 19, wherein programming instructions for updating the feature descriptors access policy comprises:
upon determining that one or more distance values have exceeded the threshold:
updating the first set of feature descriptors to include the second plurality of feature descriptors; and
updating the second set of feature descriptors to include additional feature descriptors corresponding to a third subset of image frames of the plurality of image frames:
otherwise:
updating the second set of feature descriptors to include additional feature descriptors corresponding to a third subset of image frames of the plurality of image frames.
